(19) United States
(12) Patent Application Publication
(10) Pub. No.: US 2011/0243632 A1
(43) Pub. Date: Oct. 6, 2011

(54) Media position sensing

(75) Inventors: Timothy W. Rawlings, Waynesville, OH (US); Richard B. Moreland, Centerville, OH (US); David Dashiell, Miamisburg, OH (US); Joseph D. Roth, Springboro, OH (US); Michael J. VanDemark, Springboro, OH (US); Mary Ann Wehr, Hamilton, OH (US)

(73) Assignee: NCR Corporation, Dayton, OH (US)

(21) Appl. No.: 12/798,179

(22) Filed: Mar. 31, 2010

(51) Int. Cl. B41J 11/42; B32B 7/00

(52) U.S. Cl. 400/582; 428/343

(57) ABSTRACT

Media positioning sensing techniques are presented. A position on a substrate is detected based on adhesive or characteristics that enhance an adhesive applied to the substrate.

### BACKGROUND

Print media now comes in a variety of forms. One such form is a continuous roll. The roll is inserted into a printer and sense marks are used to determine a variety of actions, such as: prompting the printer to print, prompting the printer to stop printing, prompting the printer to advance the roll of media a defined length, prompting the printer to cut a piece of the media off the roll, and the like.

Traditionally, the roll is prefabricated before it is inserted into the printer with black sense marks. This adds a step in the production process of the roll and limits the functionality of the media within the printer to the prefabricated locations of the black sense marks. So, the black sense marks are custom fabricated on the roll for specific customers or applications and when different customer needs arise a different roll of media with different prefabricated black sense marks is needed.

Another issue with the black sense marks, which may or may not be problematic depending on the needs of a customer, is that the black sense marks are visible on the piece of media cut from the roll after a print job concludes.

### SUMMARY

In various embodiments, techniques for sensing position on media are presented. According to an embodiment, a media position sensing method is presented. A sensor of a printer detects a position on a substrate; the position is elevated with respect to a top surface of the substrate. Next, an action to reposition or cut the substrate is performed in response to the detected position.

### BRIEF DESCRIPTION OF THE DRAWINGS

FIG. 1 is a diagram of method for media position sensing, according to an example embodiment.

FIG. 2. is a diagram of a substrate with an adhesive coated thereon, according to an example embodiment.

FIG. 3 is a diagram of a printing apparatus with media position sensing, according to an example embodiment.

### DETAILED DESCRIPTION

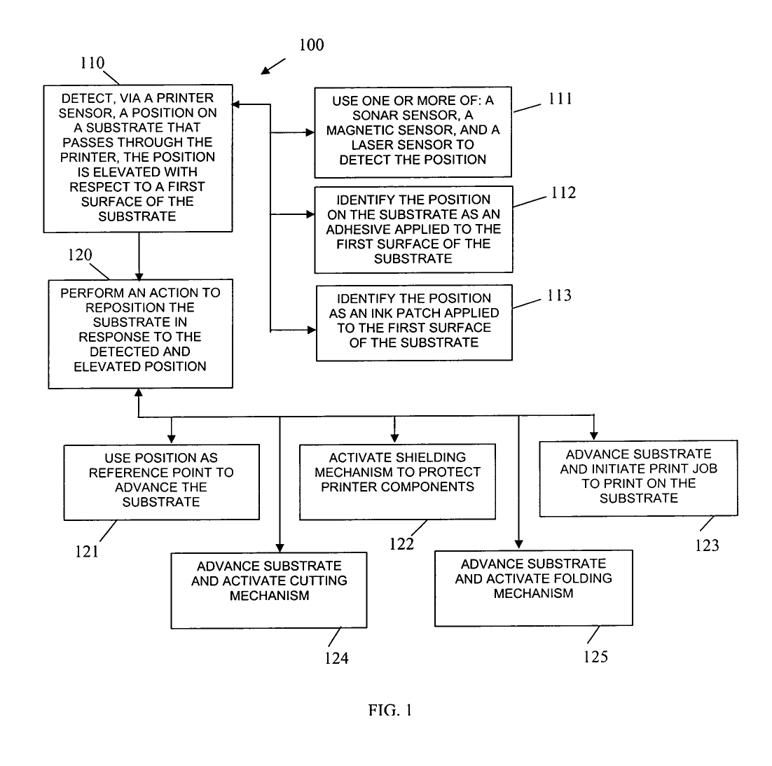

FIG. 1 is a diagram of method 100 for media position sensing, according to an example embodiment. The method 100 (hereinafter referred to as “media position sensor”) resides in a non-transitory processor-readable storage medium. One or more processors are specifically configured to execute the media position sensor. The processors are embedded in a printer or printing apparatus. In some cases, the printer or printing apparatus is accessible and operational over a network, such a Local Area Network (LAN), Wide Area Network (WAN, e.g., Internet, etc.), and the like.

According to an embodiment, the printer having the media position sensor is a dual sided thermal printer. Although it is noted that the techniques of the media position sensor may also be operational in other printers, such as a single sided thermal printer, a laser printer, an inkjet printer, and others.

At 110, the media position sensor detects, via a sensor integrated in the printer, a position on a substrate. The position is detected by the sensor based on its elevation with respect to a top surface of the substrate. So, the sensor is enabled to detect depth and it detects an increase in height above the surface of the substrate at the position on the substrate.

The substrate is print media. In an embodiment, the substrate is coated on both sides with thermal sensitive inks and the printer is a dual-sided thermal printer. In one case, the substrate is a web or receipt on roll media that is a continuous roll that passes through the printer and is cut to dispense receipts and/or labels.

According to an embodiment, at 111, the media position sensor uses a sonar sensor, a magnetic sensor, or a laser sensor to detect the elevated position on the substrate. In some cases, a combination or dual sensor is used that can be any combination or all of the above-mentioned sensors.

In an embodiment, at 112, the media position sensor identifies the elevated position on the substrate as an adhesive applied or coated to the top surface of the substrate. So, an adhesive coated randomly or in any manner by which it was fabricated can be detected in a real time and dynamic fashion by the media position sensor when the media position sensor detects the elevated position using the sensor.

In another case, at 113, the media position sensor identifies the elevated position on the substrate as an ink patch applied to the top surface of the substrate. So, any applied ink patch is detected based on its elevation above the top surface of the substrate. It is noted that the ink may be transparent in the visible spectrum.

At 120, the media position sensor performs an action to reposition the substrate in response to the detected position. A variety of movements of the substrate and actions can be performed, each of which can be configured as settings to the media position sensor or obtained based on a type of print job or type of print media used as the substrate.

According to an embodiment, at 121, the media position sensor uses the detected and elevated position as a reference point to advance the substrate within the printer a configurable length for purposes of repositioning the substrate. So, custom configuration parameters or settings used by the media position sensor can cause the media position sensor to move the substrate within the printer or position it within the printer for the action to be performed. The direction of movement and length of movement can be configured into the media position sensor relative to the detected elevated position or dynamically configured based on a type of substrate or media or type of print job being processed.

In an embodiment, at 122, the media position sensor activates a shielding mechanism to protect mechanical components of the printer from the position and a configurable amount of surrounding area of the position when the position is detected as being an adhesive applied to the bottom surface of the substrate. In one case, the shielding mechanism is a plate that protects the components when it is automatically interposed between the components of the printer and the substrate. In another case, the shielding mechanism is an action within the printer that moves some of the components off the surface of the substrate to avoid contact with the adhesive.

In another situation, at 123, the media position sensor advances the substrate within the printer a predefined length and initiates a print job to print on the substrate at the advanced location. Printing may entail apply heat to the surface of the substrate at the advanced location to activate thermally sensitive ink coated on the surface of the substrate. Printing may also entail using an ink jet or laser approach to coat ink onto the surface of substrate at the advanced location.

In still another case, at 124, the media position sensor advances the substrate within the printer a predefined length activating a cutting mechanism to cut a piece of the substrate and separate that piece from the printer and a roll or web of substrate passing through the printer.

In yet another scenario, at 125, the media position sensor advances the substrate within the printer a predefined length activating a folding mechanism to fold the substrate before dispensing the substrate from the printer.

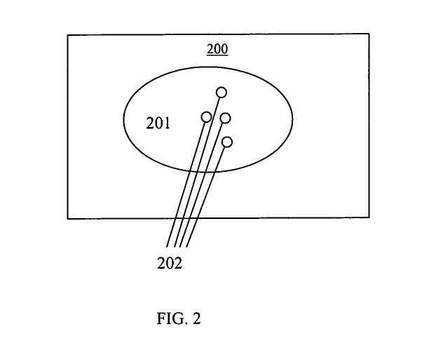

FIG. 2. is a diagram of a substrate 200 with an adhesive coated thereon, according to an example embodiment. In an embodiment, the substrate 200 can be used in the manner described above with reference to the method 100 of the FIG. 1 to detect position based on depth or proximity detecting on the substrate 200.

Additionally, the FIG. 2 describes an enhanced mechanism for detecting positions on the substrate 200 that was not discussed above with reference to the method 100. Specifically, the substrate 200 includes additional attributes (as described below) that can permit optical sensors and other types of sensors to detect an adhesive's position on the substrate 200 where these sensors are not depth or proximity sensitive, as was the sensors described above with reference to the method 100 of the FIG. 1.

The components and attributes of the substrate 200 are described here with reference to the FIG. 2.

The substrate 200 includes an adhesive 201 having added characteristics 202. These added characteristics 202 are either manufactured with the adhesive 201 when it is fabricated or added to the adhesive 200 after the adhesive 201 is fabricated. In fact, the added characteristics 202 (as will be described below) can be coated or applied to the adhesive 201 after the adhesive 201 is coated on the substrate 200. Alternatively, the added characteristics 202 can be integrated with the adhesive 201 before the adhesive 201 is coated or applied to the substrate 200.

The added characteristics 202 make a position of the adhesive 201 on a surface of the substrate 200 discernable to a sensor that is integrated into a printer. That is, the added characteristics 202 enable the adhesive 201 to be detected by various types of sensors integrated within the printer. Once the position is known, the printer can take a variety of configurable actions, as was discussed above with reference to the method 100 of the FIG. 1.

In an embodiment, the added characteristics 202 include one or more of dyes, inks, and pigments that is detectable by the sensor of the printer, where the sensor is an optical sensor. So, essentially the adhesive 201 is colored and used as a position located on the substrate 200.

In another case, the added characteristics 202 include one or more compounds that make the adhesive 201 photoluminescent. Here, the sensor consists of a UV light source and a photodetector. An example of a photodetector is a photo diode. A filter is frequently added to prevent the UV light from reaching the photodetector. The UV light stimulates photoluminescence in the compounds added to the adhesive. The resulting photoluminescence is detected by the photodetector. The photoluminescence is only visible under UV light. So, the added characteristics 202 are not discernable to the naked eye under normal illumination.

In another configuration, the added characteristics 202 include a ferrofluid that makes the adhesive 201 detectable via its magnetic signature or attributes. Here, the sensor is a magnetic sensor. Essentially, the ferrofluid becomes polarized in the presence of a magnetic field integrated into the sensor and the adhesive 201 is detected at its position on the surface of the substrate 200.

In yet another situation, the added characteristics 202 include one or more compounds that make the adhesive 201 detectable via an infrared (IR) signature or attribute. In this case the sensor consists of a infrared light source and an infrared photodectector. This scheme takes advantage of high infrared reflectivity of most common substrates. The adhesive is either intrinsically or doped to be an infrared absorber. The infrared light is reflected from the substrate and detected by the photodetector. The adhesive is sensed by the reduction of infrared light reaching the photodetector.

In another case, the adhesive 201 absorbs UV light without generating photoluminescence. This maybe an intrinsic property of the adhesive or compounds may be added to the adhesive to enhance the UV absorption. In this case the substrate is photoluminescent. This is often an intrinsic property of the substrate as optical brighteners (photoluminescent materials) are often added to paper to enhance the brightness. If the substrate is not intrinsically photoluminescent a coating can be added to make it so. The sensor consists of a UV light source and a photodetector. The UV light stimulates photoluminescence in the substrate. The adhesive absorbs the UV light before it reaches the substrate. This starves the paper of UV light and prevents photoluminescence. Thus the adhesive appears as a dark area to the sensor.

The substrate 200 is coated on one side or both sides with an adhesive 201 that has been augmented with the added characteristics 202. The added characteristics 202 permit the adhesive to be detectable on the surface or surfaces via a sensor that is integrated into the printer through which the substrate 200 passes.

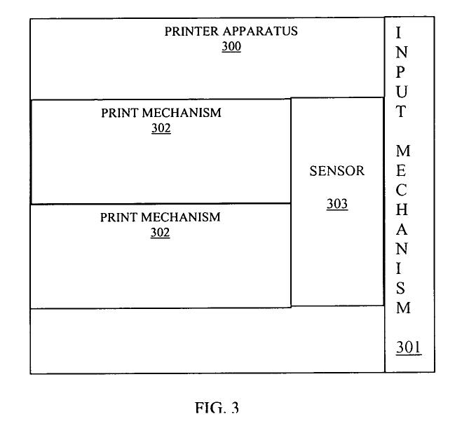

FIG. 3 is a diagram of a printing apparatus with media position sensing 300, according to an example embodiment. The printing apparatus with media position sensing 300 is implemented as a printer configured to provide the features of the methods 100 and 200 for the FIGS. 1 and 2, respectively.

The printing apparatus with media position sensing 300 includes a substrate input mechanism 301, a print mechanism 302, and a sensor 303. Each of these and their interaction with one another will now be discussed in turn.

The substrate input mechanism 301 is configured to receive a substrate within the printer apparatus 300. In an embodiment, the substrate input mechanism 301 is a tray that houses sheets of the substrate. In another case, the substrate input mechanism 301 is a spindle that holds and dispenses a continuous web of the substrate through the printer apparatus 300. In still another scenario, the substrate input mechanism 301 is a manual feeder that is designed to manually receive single sheets or the substrate; the input mechanism 301 can also support fan fold.

According to an embodiment, the substrate 301 is coated with thermally sensitive inks on one or both sides of the substrate. The substrate also includes an adhesive. In some cases, the adhesive is enhanced with added characteristics as was discussed above with reference to the substrate 200 of the FIG. 2. In other cases, the adhesive is not enhanced with any added characteristics; here, the sensor 303 is enabled to detect proximity of depth on one or both surfaces of the substrate to detect where the adhesive is coated on the substrate.

The print mechanism 302 is configured to activate or apply ink to the substrate and the substrate passes from the substrate input mechanism 301 to the print mechanism 302.

In an embodiment, the print mechanism 302 is a dual-sided thermal print head and the print mechanism is configured to active thermal inks coated on both sides of the substrate by selectively applying a heat source to the surfaces of the substrate as the print heads pass over the surfaces of the substrate

In another case, the print mechanism 302 is a one or more ink jet print heads or laser print heads that selective apply ink to the surface or surfaces of the substrate as the print heads pass over the surfaces of the substrate.

The sensor 303 is configured to detect a position on the substrate based on the presence of the adhesive appearing at the position. It is noted, that the sensor 303 uses the adhesive to detect the position and is not simply a mechanism that advances to a predefined location based on a specific type of media (substrate) that identifies the position on a sheet or roll of the substrate. So, the adhesive can be randomly applied to the substrate in patterns or no patterns at all and the sensor 303 detects the position of the substrate.

According to an embodiment, the sensor 303 is one or more of: optical, magnetic, UV, and/or IR, as was discussed above with reference to the substrate 200 of the FIG. 2.

In one scenario, the sensor 303 is configured to detect the adhesive based on added characteristics integrated into the adhesive. Such characteristics were discussed above with reference to the substrate 200 of the FIG. 2.

In another case, the sensor 303 is configured or enabled to detect a depth, elevation, or proximity of the adhesive as the adhesive appears above a surface of the substrate and as that substrate passes through the printer apparatus 300. Such a sensor 303 was discussed above with reference to the method 100 of the FIG. 1.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method to process on a printer, comprising:
detecting, via a sensor of the printer, a position on a substrate passing through the printer, the position is elevated with respect to a first surface of the substrate; and
performing an action to reposition the substrate in response to the detected position.

2. The method of claim 1, wherein detecting further includes using one or more of: a sonar sensor, a magnetic sensor, and a laser sensor to detect the elevated position on the substrate.

3. The method of claim 1, wherein detecting further includes identifying the elevated position on the substrate as an adhesive applied to the first surface of the substrate.

4. The method of claim 1, wherein detecting further includes identifying the elevated position on the substrate as an ink patch applied to the first surface of the substrate.

5. The method of claim 1, wherein performing further includes using the position as a reference point to advance the substrate within the printer a configurable length for purposes of repositioning the substrate.

6. The method of claim 1, wherein performing further includes activating a shielding mechanism to protect mechanical components of the printer from the position and a configurable surrounding area of the position when the position is detected as being an adhesive applied to the first surface of the substrate.

7. The method of claim 1, wherein performing further includes advancing the substrate within the printer a predefined length and initiating a print job to print on the substrate at the advanced location.

8. The method of claim 1, wherein performing further includes advancing the substrate within the printer a predefined length and activating a cutting mechanism to cut a piece of the substrate off and separate the piece from the printer.

9. The method of claim 1, wherein performing further includes advancing the substrate within the printer a predefined length and activating a folding mechanism to fold the substrate before dispensing the substrate from the printer.

10. A substrate, comprising:
an adhesive having added characteristics, the added characteristics make a position of the adhesive on the substrate discernable to a sensor that is integrated into a printer.

11. The substrate of claim 10, wherein the added characteristics include one or more of: a dye, an ink, and a pigment that is detected by the sensor that is an optical sensor.

12. The substrate of claim 10, wherein the added characteristics include a compound to make the adhesive detectable in a preconfigured ultraviolet (UV) range and the sensor is a UV sensor.

13. The substrate of claim 12, wherein the UV range is outside the visible spectrum.

14. The substrate of claim 10, wherein the added characteristics include a ferrofluid to make the adhesive detectable via its magnetic characteristics and the sensor is a magnetic sensor.

15. The substrate of claim 10, wherein the added characteristics include a compound to make the adhesive detectable via an infrared (IR) signature and the sensor is an IR sensor.

16. The substrate of claim 10, wherein the added characteristics include an ultraviolet (UV) absorber to make the adhesive appear darker to the sensor relative to surrounding areas of the substrate, the sensor a UV sensor.

17. A printer apparatus, comprising:
a substrate input mechanism configured to receive a substrate in the printer apparatus;
a print mechanism configured to activate or apply ink to the substrate; and
a sensor configured to detect a position on the substrate based on the presence of an adhesive appearing at the position.

18. The printer apparatus of claim 17, wherein the sensor is one or more of: optical, magnetic, ultraviolet, and infrared.

19. The printer apparatus of claim 17, wherein the printer apparatus is a dual-sided thermal printer and the print mechanism configured to activate thermal inks coated on a surface of the substrate.

20. The printer apparatus of claim 17, wherein the sensor is configured to detect a depth of the adhesive that appears above a surface of the substrate as the substrate passes through the printer apparatus.

21. The printer apparatus of claim 17, wherein the sensor is configured to detect the adhesive based on added characteristics integrated into the adhesive.
